(19) United States
(12) Patent Application Publication
(10) Pub. No.: US 2025/0376185 A1
(43) Pub. Date: Dec. 11, 2025

(54) VEHICLE CONTROL DEVICE AND VEHICLE CONTROL METHOD

(71) Applicant: DENSO CORPORATION, Kariya-city (JP)

(72) Inventor: Takuya Kume, Kariya-city (JP)

(21) Appl. No.: 19/312,238

(22) Filed: Aug. 27, 2025

Related U.S. Application Data
(63) Continuation of application No. PCT/JP2024/004320, filed on Feb. 8, 2024.

(30) Foreign Application Priority Data
Mar. 2, 2023 (JP) 2023-032171

(51) Int. Cl. B60W 50/14; B60W 30/14; B60W 40/08; B60W 60/00

(52) U.S. Cl. CPC B60W 50/14; B60W 30/146; B60W 40/08; B60W 60/0015; B60W 2040/0818; B60W 2050/143; B60W 2050/146; B60W 2540/229

(57) ABSTRACT

A vehicle control device can be used in a vehicle configured to start automated driving that assists steering, acceleration, and deceleration from a traveling start time, identifies a traveling start state which is a state related to the automated driving that starts at the traveling start time, causes a notification device for providing a notification to an occupant of the vehicle to provide the notification, and changes content of the notification by the notification device.

### CROSS REFERENCE TO RELATED APPLICATIONS

The present application is a continuation application of International Patent Application No. PCT/JP2024/004320 filed on Feb. 8, 2024, which designated the U.S. and claims the benefit of priority from Japanese Patent Application No. 2023-032171 filed on Mar. 2, 2023. The entire disclosures of all of the above applications are incorporated herein by reference.

### TECHNICAL FIELD

The present disclosure relates to a vehicle control device and vehicle control method.

### BACKGROUND

For example, a technology for switching between manual driving and automated driving in a vehicle equipped with an automated driving function has been known as a comparative example. Further, a technology of starting operation of an automated driving function by detecting an operation by a driver to switch to the automated driving in an area where the automated driving is possible has been known as the comparative example.

### SUMMARY

According to an aspect of the present disclosure, a vehicle control device is configured to be used in a vehicle configured to start automated driving that assists steering, acceleration, and deceleration from a traveling start time, and includes at least one of (i) a circuit and (ii) a processor with a memory storing computer program code executable by the processor, the at least one of the circuit and the processor configured to cause the vehicle control device to: identify a traveling start state related to the automated driving that starts at the traveling start time; cause a notification device to provide a notification; and change content of the notification.

### BRIEF DESCRIPTION OF THE DRAWINGS

FIG. 1 is a diagram showing an example of a schematic configuration of a vehicle system according to a first embodiment.

FIG. 2 is a diagram showing an example of a schematic configuration of an automated driving ECU according to the first embodiment.

FIG. 3 is a flowchart showing an example of a flow of a traveling start-related process by the automated driving ECU according to the first embodiment.

FIG. 4 is a flowchart showing an example of a flow of a traveling necessary time process by the automated driving ECU according to the first embodiment.

FIG. 5 is a flowchart showing an example of a flow of a traveling unnecessary time process by the automated driving ECU according to the first embodiment.

FIG. 6 is a flowchart showing an example of a flow of a last mile-related process in the automated driving ECU according to the first embodiment.

FIG. 7 is a diagram showing an example of a schematic configuration of a vehicle system according to a second embodiment.

FIG. 8 is a diagram showing an example of a schematic configuration of the automated driving ECU according to the second embodiment.

### DETAILED DESCRIPTION

In the comparative example, although in an assumed case where the vehicle transitions from manual driving to automated driving, there may also be cases where the vehicle starts traveling by automated driving from the start of traveling. Even when such a vehicle travels with the automated driving from the traveling start, there is a demand to improve convenience for occupants.

One aspect of the present provides a vehicle control device and a vehicle control method capable of improving convenience for an occupant when the vehicle travels by automated driving from the time the occupant gets in the vehicle.

According to an example embodiment of the present disclosure, a vehicle control device is configured to be used in a vehicle configured to start automated driving that assists steering, acceleration, and deceleration from a traveling start time, and the vehicle control device includes: a traveling start state identification unit configured to identify a traveling start state which is a state related to the automated driving that starts at the traveling start time; and a notification processing unit configured to cause a notification device for providing a notification to an occupant of the vehicle to provide the notification. The notification processing unit changes the content of the notification made by the notification device according to the traveling start state identified by the traveling start state identification unit.

According to another example embodiment of the present disclosure, a vehicle control method can be used in a vehicle configured to start automated driving that assists steering, acceleration, and deceleration from a traveling start time, and the vehicle control method includes causing at least one processor to: a traveling start state identification process of identifying a traveling start state which is a state related to the automated driving that starts at the traveling start time; and a notification process of causing a notification device for providing a notification to an occupant of the vehicle to provide the notification. The notification process changes content of the notification by the notification device according to the traveling start state identified by the traveling start state identification process.

According to the above configuration, for a vehicle capable of starting automated driving, which assists the steering, acceleration, and deceleration, from the traveling start time, it is possible to provide notification according to the state of the automated driving that starts from the traveling start time. Therefore, it becomes possible to provide useful information to the occupant depending on the state of the automated driving that starts when the vehicle starts traveling. As a result, when the vehicle starts traveling by the automated driving from the time when the occupant gets in the vehicle, it becomes possible to improve convenience for the occupant.

The following will describe embodiments of the present disclosure with reference to the accompanying drawings. For convenience of description, among multiple embodiments, a configuration having the same function as a configuration shown in the drawing and described in the previous embodiment may be indicated by the same reference numeral, and the description thereof may be omitted. The description of other embodiments may be referred to with respect to these portions given the same reference numerals.

### First Embodiment

### Schematic Configuration of Vehicle System

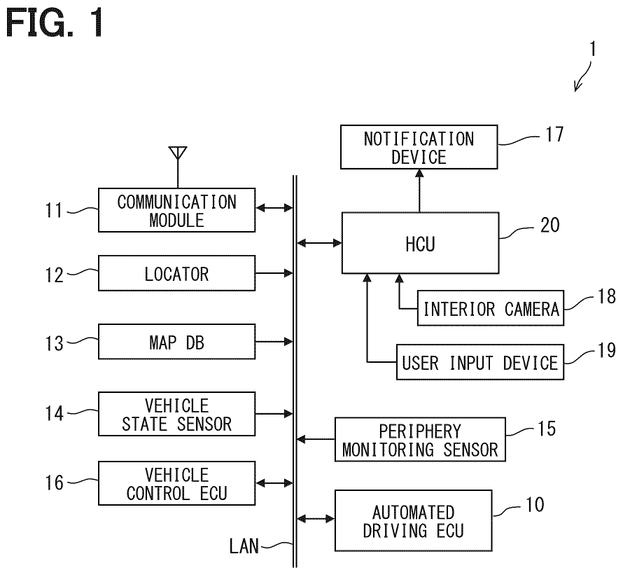

Hereinafter, a first embodiment according to the present disclosure will be described with reference to the drawings. A vehicle system 1 shown in FIG. 1 can be used for a vehicle (hereinafter referred to as an automated driving vehicle) configured to perform automated driving. As shown in FIG. 1, the vehicle system 1 includes an automated driving ECU 10, a communication module 11, a locator 12, a map database (hereinafter referred to as map DB) 13, a vehicle state sensor 14, a periphery monitoring sensor 15, a vehicle control ECU 16, a notification device 17, an interior camera 18, a user input device 19, and a HCU (Human Machine Interface Control Unit) 20. For example, the automated driving ECU 10, the communication module 11, the locator 12, the map DB 13, the vehicle state sensor 14, the periphery monitoring sensor 15, the vehicle control ECU 16, and the HCU 20 are connected to a vehicle interior LAN (see LAN in FIG. 1). Although the vehicle using the vehicle system 1 is not necessarily limited to an automobile, hereinafter, an example using the automobile will be described.

There may be multiple stages (hereinafter, referred to as automation levels) of automated driving of an automated driving vehicle, for example, as defined by SAE (the Society of Automotive Engineers). The automation levels are classified into, for example, five levels including LV0 to LV5 as follows.

The LV0 is a level where a driver performs all driving tasks without intervention of the system. The driving tasks may be referred to as dynamic driving tasks. The driving tasks are, for example, steering, acceleration and deceleration, and periphery monitoring. The LV0 corresponds to so-called manual driving. The LV1 is a level at which the system assists either the steering or the acceleration and deceleration. The LV1 corresponds to so-called driving assistance. The LV2 is a level at which the system assists both the steering and the acceleration and deceleration. The LV2 corresponds to so-called partial driving automation. The LV1 and LV2 are also part of automated driving.

For example, the automated driving at LV1 and LV2 is automated driving in which a driver has an obligation of monitoring related to safe driving. Hereinafter, the obligation is simply referred to as a monitoring obligation. That is, this corresponds to automated driving with the monitoring obligation. Incidentally, operations at LV0 to LV2 correspond to driving operations requiring monitoring obligation. As part of the monitoring obligation, there is visual monitoring of the periphery. The automated driving at LV1 and 2 can be referred to as automated driving in which a second task is not permitted. The second task is an action other than driving which the driver is permitted to perform, and is a specific action defined in advance. The second task can also be referred to as a secondary activity, other activities, or the like. The second task must not prevent the driver from responding to a request to take over a driving operation from an automated driving system. As an example, viewing of the content such as a video, operation of a smartphone, reading, and eating are assumed as the second task.

The LV3 of the automated driving is a level where the system performs all driving tasks under certain conditions, and the driver performs the driving operation in an emergency situation. In the automated driving at the LV3, it is required that the driver can quickly respond to a request of driving takeover from the system. The driving takeover can also be referred to as transfer of the periphery monitoring obligation from the vehicle system to the driver. The LV3 corresponds to so-called conditional driving automation. The automated driving at the LV4 is at a level at which the system can perform all the driving tasks except for a specific situation such as a road or a limit environment which cannot be handled. The LV4 corresponds to so-called advanced driving automation. The LV5 of the automated driving is a level at which the system can perform all the driving tasks under all environments. The LV5 corresponds to a full driving automation. The automated driving at LV4 and LV5 may be implemented, for example, in a traveling section where high-precision map data is prepared. The high-precision map data will be described later.

For example, the automated driving at LV3 or higher is an automated driving in which the driver does not have the monitoring obligation. In other words, the automated driving corresponds to automated driving without the monitoring obligation. The automated driving at LV3 or higher can be referred to as automated driving in which the second task is permitted. For example, the automated driving at LV4 or higher is automated driving in which the driver is allowed to sleep. In other words, the automated driving corresponds to sleep-permitted automated driving. The automated driving vehicle of the present embodiment may be configured to switch the automation levels, for example. The automation levels may be configured to be switchable only between a part of the levels among LV0 to LV5. In the present embodiment, it is assumed that the automated driving vehicle is capable of performing automated driving of at least LV2 or higher from the traveling start time. The “traveling start time” refers to when an occupant gets in an unmanned automated driving vehicle and the vehicle starts traveling.

The communication module 11 transmits and receives information to and from a center outside the subject vehicle via wireless communications. That is, the communication module 11 performs a wide area communication. The communication module 11 receives traffic congestion information and the like from the center through the wide area communication. The communication module 11 may transmit and receive information to and from other vehicles via the wireless communication. In other words, the communication module 11 may perform a vehicle-to-vehicle communication. The communication module 11 may transmit and receive information via the wireless communication with a roadside device installed on a roadside. In other words, the communication module 11 may perform a road-to-vehicle communication. When performing the road-to-vehicle communication, the communication module 11 may receive peripheral vehicle information transmitted from the vehicle positioned in the peripheral of the subject vehicle via the roadside device. Further, the communication module 11 may receive information about a peripheral vehicle transmitted from the vehicle positioned in the periphery of the subject vehicle via the center by the wide area communication.

The locator 12 includes a GNSS (Global Navigation Satellite System) receiver and an inertial sensor. The GNSS receiver receives positioning signals from multiple positioning satellites. The inertial sensor includes, for example, a gyro sensor and an acceleration sensor. The locator 12 combines the positioning signals received by the GNSS receiver with a measurement result of the inertial sensor to sequentially detect the position of the subject vehicle (hereinafter, subject vehicle position). The subject vehicle position may include, for example, coordinates of latitude and longitude. The subject vehicle position may be measured by using a traveling distance acquired from signals sequentially output from a vehicle speed sensor mounted on the vehicle.

The map DB 13 is a non-volatile memory and stores the high-precision map data. The high-precision map data is map data with higher precision than the map data used for route guidance in a navigation function. The high-precision map data includes information that can be used for the automated driving operation, such as, for example, three-dimensional road shape information, information on the number of lanes, and information indicating the traveling direction allowed for each lane. In addition, the high-precision map data may also include, for example, node point information indicating the positions of both ends of a road marking such as a lane marking. The map DB 13 may also store map data used for route guidance. The locator 12 may be configured without the GNSS receiver by using the three-dimensional shape information of the road. For example, the locator 12 may be configured to identify the subject vehicle position using three-dimensional shape information of the road and the detection results of the periphery monitoring sensor 15. The three-dimensional shape information of the road may be generated based on a captured image by REM (Road Experience Management).

Map data distributed from an external server distributed through, for example, wide area communications may be received by a communication module 11 and stored in the map DB 13. In this case, the map DB 13 may be a volatile memory, and the communication module 11 may sequentially acquire the map data of an area corresponding to the subject vehicle position.

The vehicle state sensor 14 is a sensor group for detecting various states of the subject vehicle. The vehicle state sensor 14 includes a vehicle speed sensor, an accelerator stroke sensor, a seat belt sensor, and the like. The vehicle speed sensor detects the speed of the subject vehicle. The accelerator stroke sensor detects depression amount of the accelerator pedal. The seat belt sensor outputs a signal according to whether the occupant has fastened a seat belt. That is, the seat belt sensor detects whether the occupant has fastened. the seat belt. The vehicle state sensor 14 outputs detected sensing information to the vehicle interior LAN. Note that the sensing information detected by the vehicle state sensor 14 may be output to the vehicle interior LAN via an ECU mounted on the subject vehicle.

The periphery monitoring sensor 15 monitors a peripheral environment of the subject vehicle. For example, the periphery monitoring sensor 15 detects an obstacle in a peripheral of the subject vehicle, such as a pedestrian, a mobile object like the other vehicle, and a stationary object, and an object on the road. The periphery monitoring sensor 15 further detects a road surface marking such as a traffic lane marking around the subject vehicle. The periphery monitoring sensor 15 is, for example, a periphery monitoring camera that captures an image of a predetermined range around the vehicle, or a search wave sensor that transmits search waves to a predetermined range in the periphery of the subject vehicle. Examples of search wave sensors include millimeter wave radar, sonar, and LIDAR (Light Detection and Ranging/Laser Imaging Detection and Ranging). For example, the predetermined range may be a range at least partially including the front, rear, left, and right areas of the subject vehicle. The periphery monitoring camera sequentially outputs, as sensing information, sequentially captured images to the automated driving ECU 10. The scanning wave sensor sequentially outputs to the automated driving ECU 10 as sensing information, the scanning result based on the received signal obtained when the reflected wave reflected by the obstacle is received.

The vehicle control ECU 16 is an electronic control unit configured to perform a traveling control of the subject vehicle. The traveling control includes an acceleration and deceleration control and/or a steering control. The vehicle control ECU 16 includes a steering ECU that performs the steering control, a power unit control ECU and a brake ECU that perform the acceleration and deceleration control, and the like. The vehicle control ECU 16 performs driving control by outputting control signals to each traveling control device mounted on the subject vehicle. The traveling control devices is an electronically controlled throttle, a brake actuator, an EPS (Electric Power Steering) motor, and the like.

The notification device 17 is mounted in the subject vehicle and presents information to the interior of the subject vehicle. That is, the notification device 17 provides a notification to the occupant of the subject vehicle. The notification device 17 performs notification according to the instruction from the HCU 20. The notification device 17 may be, for example, a display device, a voice output device, or the like.

The display device provides notification by displaying information. The display device may be, for example, a meter MID (Multi Information Display), a CID (Center Information Display), or a HUD (Head-Up Display). The meter MID is a display device located in front of the driver seat in the compartment of the subject vehicle. As an example, the meter MID may be provided on a meter panel. The CID is a display device disposed at a center of an instrument panel of the subject vehicle. The HUD is provided in, for example, the instrument panel in the vehicle compartment. The HUD projects a display image formed by a projector onto a predetermined projection area on a front windshield as a projection member. A light of the display image reflected by the front windshield to an inside of a vehicle compartment is perceived by the driver seated in the driver's seat. As a result, the driver can visually recognize a virtual image of the display image formed in front of the front windshield which is superimposed on a part of the foreground landscape. The HUD may project the display image onto a combiner provided in front of the driver's seat instead of the front windshield. The voice output device performs notification by outputting audio. The voice output device is a speaker and the like.

The interior camera 18 is a capturing device that captures an image of a predetermined range in the vehicle compartment of the subject vehicle. The interior camera 18 should just capture the range including the driver seat of the subject vehicle at least. The interior camera 18 may capture an image of a range including not only the driver seat of the subject vehicle but also the front passenger seat and the rear seat. The interior camera 18 includes, for example, a near-infrared light source, a near-infrared camera unit, and a control unit that controls these components. The interior camera 18 uses the near-infrared camera to capture the occupant of the subject vehicle to which the near-infrared light is emitted from the near-infrared light source.

The user input device 19 accepts input from the occupant of the subject vehicle. The user input device 19 may be an operation device that receives an operation input from the occupant. The operation device may be a mechanical switch or a touch switch integrated with the display device. The user input device 19 is not limited to the operation device that receives the operation input as long as the user input device 19 is a device that receives the input from the occupant. For example, the user input device 19 may be audio input device that receives command input by audio such as a voice from the occupant.

The HCU 20 mainly includes a computer including a processor, a volatile memory, a nonvolatile memory, an I/O, and a bus connecting these devices. The HCU 20 executes various processing related to an interaction between an occupant and a system of the subject vehicle by executing a control program stored in the nonvolatile memory. The HCU 20 acquires information of input received from the occupant via the user input device 19. The HCU 20 causes the notification device 17 to provide a notification. The HCU 20 acquires images captured by the interior camera 18. The HCU 20 identifies the state of the occupant of the subject vehicle from the images captured by the interior camera 18. The HCU 20 may detect the presence, the facial orientation, and line of sight of the subject vehicle occupant using image recognition technology. The HCU 20 may detect the presence of the occupant by recognizing the face of the occupant from the captured image. The state of the occupant of the subject vehicle may be determined by the control unit of the interior camera 18.

The automated driving ECU 10 mainly includes a computer including a processor, a volatile memory, a nonvolatile memory, an I/O, and a bus connecting these devices, for example. The automated driving ECU 10 executes processing related to automated driving by executing a control program stored in the nonvolatile memory. The automated driving ECU 10 corresponds to a vehicle control device. The configuration of the automated driving ECU 10 will be described in detail below.

### Schematic Configuration of Automated Driving ECU

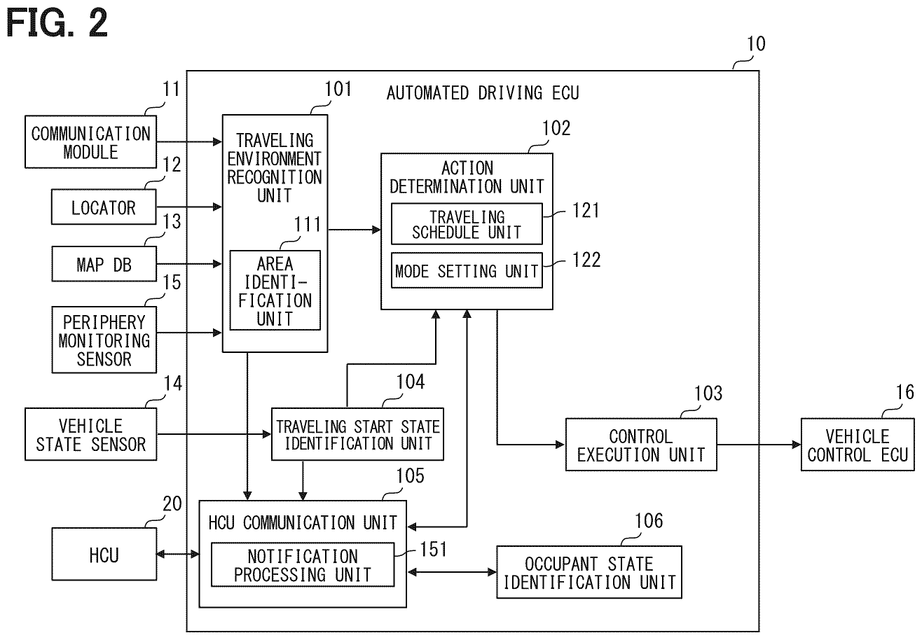

Next, a schematic configuration of the automated driving ECU 10 will be described with reference to FIG. 2. As shown in FIG. 2, the automated driving ECU 10 includes a traveling environment recognition unit 101, an action determination unit 102, a control execution unit 103, a traveling start state identification unit 104, an HCU communication unit 105, and an occupant state identification unit 106 as functional blocks. The execution of the processes of the functional blocks of the automated driving ECU 10 by the computer corresponds to execution of a vehicle control method. Some or all of the functions executed by the automated driving ECU 10 may be implemented as hardware with one or more ICs or the like. Some or all of the functional blocks included in the automated driving ECU 10 may be implemented by a combination of execution of software by a processor and a hardware member.

The traveling environment recognition unit 101 recognizes the traveling environment of the subject vehicle from the subject vehicle position, map data, and sensing information acquired from the periphery monitoring sensor 15. The subject vehicle position may be acquired from the locator 12. The map data may be acquired from the map DB 13. As one example, with use of these information, the traveling environment recognition unit 101 recognizes a position of an object in peripheral of the subject vehicle, a shape, and a movement state, and generates a virtual space in which the actual traveling environment is reproduced. The traveling environment recognition unit 101 may recognize a peripheral vehicle that is a vehicle in the periphery of the subject vehicle from the sensing information. More specifically, the traveling environment recognition unit 101 may recognize presence of the peripheral vehicle, a relative position of the peripheral vehicle relative to the subject vehicle, a relative speed of the peripheral vehicle relative to the subject vehicle, and the like as the traveling environment.

Further, the traveling environment recognition unit 101 may recognize the position of the subject vehicle on the map from the subject vehicle position and the map data. In a case where position information, speed information, and the like of the peripheral vehicle can be acquired via the communication module 11, the traveling environment recognition unit 101 may recognize the traveling environment using these pieces of information. The traveling environment recognition unit 101 includes an area identification unit 111 as a sub-functional block. The area identification unit 111 separately identifies, as a traveling area of the subject vehicle, at least two types of areas according to the necessity for the occupant to monitor the periphery. Specifically, a first area where the necessity for periphery monitoring is higher and a second area where the necessity for periphery monitoring is lower are separately identified. The first area includes parking lots, congested areas with many pedestrians, and the like. The second area includes general roads other than the first area. The area identification unit 111 may identify the first area and the second area based on the map data.

The action determination unit 102 switches the control subject of driving operation control between the driver and the system of the subject vehicle. In the present embodiment, the subject vehicle transitions to automated driving at LV2 or higher from the traveling start. In addition, the setting of whether to switch to automated driving when starting and the automation level at that time may be able to be set in advance. This setting may be performed in response to an input received by the user input device 19. In a case where the control right of the driving operation is on the system side, the action determination unit 102 determines a traveling schedule for causing the subject vehicle to travel based on the recognition result of the traveling environment by the traveling environment recognition unit 101. The action determination unit 102 includes a traveling schedule unit 121, a mode determination unit 122 as sub-functional blocks.

The traveling schedule unit 121 determines a traveling schedule for causing the subject vehicle to travel by the automated driving. The traveling schedule unit 121 determines a long-to medium-term traveling schedule and a short-term traveling schedule as traveling schedules. In the long-to medium-term traveling schedule, a scheduled route for causing the subject vehicle to travel toward a set destination is determined. The traveling schedule unit 121 may determine this scheduled route in a manner similar to the route search of the navigation function. The traveling schedule unit 121 may also determine the set vehicle speed when traveling along the scheduled route. The traveling schedule unit 121 uses the virtual space around the subject vehicle generated by the traveling environment recognition unit 101 to determine the short-term traveling schedule for implementing traveling in accordance with the long-to medium-term traveling schedule. Specifically, as the short-term traveling schedule, the execution of steering for lane changes, acceleration/deceleration for speed adjustment, and steering and braking for obstacle avoidance are determined.

The mode determination unit 122 determines a mode related to automated driving. This mode related to automated driving will be referred to as an automated driving-related mode hereinafter. The automated driving-related modes include a mode based on the start condition of automated driving, a mode based on the type of automated driving, and the like. The modes according to the start condition of the automated driving include a traveling start operation necessary mode and the traveling start operation unnecessary mode. The traveling start operation unnecessary mode is a mode in which the traveling start operation by the occupant is not required for the traveling start of automated driving from the traveling start of the subject vehicle. In the traveling start operation unnecessary mode, the subject vehicle starts traveling by automated driving when an operation input for operating the traveling driving source is performed as a trigger. The traveling driving source includes an internal combustion engine or a motor generator. The switch operation input for starting the internal combustion engine is to turn on the ignition power. The switch operation input for starting the motor generator is to turn on the system main relay power supply. The ignition power supply and the system main relay power source may be turned on, for example, by turning on a power switch. In the following description, it is assumed that the ignition power source and the system main relay power source are turned on by turning on the power switch. The traveling start operation necessary mode is a mode in which the traveling start operation by the occupant is required to start the automated driving from the traveling start of the subject vehicle. In the traveling start operation necessary mode, the subject vehicle will not start traveling in an automated driving mode unless a specific traveling start operation is performed by the occupant, even when the driving source for traveling is operated. The specific traveling start operation is, for example, depressing the accelerator pedal.

The mode based on the type of automated driving includes a last mile mode and a normal traveling mode. The last mile mode is a mode for performing last mile automated driving. The last mile automated driving is automated driving that moves by automated driving within a limited range, i.e., a range limited to a destination. The limited range may be, for example, about one mile (about 1.6 kilometers). The normal traveling mode is the default automated driving mode. In other words, this is a mode in which automated driving is performed other than last mile automated driving. In addition, the automated driving-related modes may include modes other than those described above. For example, the mode based on the type of automated driving may include an automatic parking mode for performing automatic parking. In this case, the normal traveling mode may be a mode in which automated driving other than last mile automated driving and automatic parking is performed.

The mode determination unit 122 may determine the automated driving- related mode to be implemented based on the setting of the automated driving-related mode that is performed in advance in response to the input received by the user input device 19. The traveling schedule unit 121 may determine a traveling plan according to the automated driving-related mode determined by the mode determination unit 122. For example, in the last mile mode, the traveling schedule may be determined so as to keep the set vehicle speed lower than in the normal traveling mode. In the normal traveling mode, for example, the set vehicle speed may be set as the speed limit for each traveling section.

The control execution unit 103 executes traveling control in cooperation with the vehicle control ECU 16 when the control right of driving operation is held by the system of the subject vehicle itself. The control execution unit 103 executes traveling control such as acceleration/deceleration control and steering control of the subject vehicle in accordance with the traveling schedule determined by the action determination unit 102. That is, the control execution unit 103 performs automated driving.

The traveling start state identification unit 104 identifies a state (hereinafter, the traveling start state) related to the automated driving that starts when the subject vehicle starts. The process by the traveling start state identification unit 104 corresponds to a traveling start state identification process. The traveling start state identification unit 104 may determine the traveling start time of the subject vehicle based on transition of the subject vehicle from a state in which no occupant is present to a state in which an occupant is present in the subject vehicle. Whether the occupant is present in the subject vehicle can be determined from the result of detection performed by the HCU 20 as to whether the occupant is present in the subject vehicle. Alternatively, it may be determined when the power switch of the subject vehicle is turned on. The traveling start state identification unit 104 identifies the automated driving-related mode determined by the mode determination unit 122 as the traveling start state. For the subject vehicle that starts traveling by the automated driving in response to an operation input to activate the driving power source for traveling of the subject vehicle, the traveling start state identification unit 104 can determine that the traveling start operation by the vehicle's occupant is not necessary to start traveling by automated driving. In other words, for a vehicle in which the traveling start operation unnecessary mode is set, it is determined that the traveling start operation is not required. In the following, the requirement for the traveling start operation by the occupant of the subject vehicle to start traveling by automated driving is referred to as a “traveling start operation necessary state”. In addition, the non-requirement for the traveling start operation by the occupant of the subject vehicle to start traveling under automated driving is referred to as a “traveling start operation unnecessary state”.

The traveling start state identification unit 104 may identify the state of the occupant's periphery monitoring as the traveling start state. The traveling start state identification unit 104 may identify the state of the occupant's periphery monitoring from the detection results of the facial orientation and line of sight direction of the occupant of the subject vehicle, the results being obtained from the HCU 20. The traveling start state identification unit 104 may determine that periphery monitoring is being performed, for example, when the amount of movement of the face orientation or the line of sight direction per unit time is equal to or greater than a threshold value. On the other hand, the traveling start state identification unit 104 may determine that periphery monitoring is not being performed, for example, when the amount of movement of the face orientation or the line of sight direction per unit time is less than the threshold value. The traveling start state identification unit 104 may identify the seat belt state of the occupant of the subject vehicle as the traveling start state. The traveling start state identification unit 104 may identify the seat belt fastening state of the occupant in the subject vehicle from the detection result of a seat belt sensor, for example.

The HCU communication unit 105 executes an output process of the information to the HCU 20 and an acquisition process of the information from the HCU 20. The HCU communication unit 105 acquires information on the input received by the user input device 19. The HCU communication unit 105 acquires information such as images captured by the interior camera 18. The HCU communication unit 105 includes a notification processing unit 151 as a sub-functional block. The notification processing unit 151 indirectly controls the notification by the notification device 17 by transmitting instructions to the HCU 20. That is, the notification processing unit 151 provides a notification to the occupant of the subject vehicle.

The notification processing unit 151 changes the content of the notification made by the notification device 17 according to the traveling start state identified by the traveling start state identification unit 104. According to the above configuration, for a vehicle capable of starting automated driving at LV2 or higher from the traveling start time, it is possible to provide notification according to the state of the automated driving that starts from the traveling start time. Therefore, it becomes possible to provide useful information to the occupant depending on the state of the automated driving that starts when the vehicle starts traveling. As a result, when the vehicle starts traveling by the automated driving from the time when the occupant gets in the vehicle, it becomes possible to improve convenience for the occupant. The process executed by the notification processing unit 151 corresponds to a notification process.

When the traveling start state identification unit 104 identifies the traveling start operation necessary state, the notification processing unit 151 preferably causes the notification device 17 to provide a monitoring encouragement notification. The monitoring encouragement notification is a notification that encourages the occupant to monitor the periphery of the subject vehicle. When the traveling start state identification unit 104 identifies the traveling start operation unnecessary state, the notification processing unit 151 does not cause the notification device 17 to provide the monitoring encouragement notification. Furthermore, the action determination unit 102 may start traveling by automated driving when determining that the traveling start operation has been performed and that the occupant is monitoring the periphery. That is, the control execution unit 103 may start traveling by automated driving when determining that the traveling start operation has been performed and that the occupant is monitoring the periphery. The action determination unit 102 may determine that the traveling start operation has been performed from sensing information of the accelerator stroke sensor, for example. The traveling start state identification unit 104 identifies whether the occupant is monitoring the periphery.

In the case of the traveling start operation necessary state, it is estimated that the occupant must bear responsibility for the start of automated driving to the extent that the traveling start operation by the occupant is required for the start of automated driving. Therefore, in case of the traveling start operation necessary state, it is considered that the occupant must pay more attention to the start of automated driving. In contrast, according to the above configuration, it is possible to encourage the occupant to monitor the periphery in cases where the occupant needs to pay more attention to the start of automated driving. In addition, it will be possible for the vehicle to start traveling by automated driving under a condition that the periphery monitoring of the occupant has been performed. As a result, the occupant is possible to start automated driving with greater peace of mind.

It is preferable that the notification processing unit 151 provide the monitoring encouragement notification when it determines that the occupant has stopped monitoring the periphery within a predetermined period after automated driving has started. The predetermined period referred to here may be a period during which it is estimated that it is preferable to continue monitoring the periphery after the traveling start by automated driving. The predetermined period may be a period until a certain distance has been traveled, or a period until a certain amount of travel has been completed. The predetermined period may be set arbitrarily. The predetermined period from when the vehicle starts traveling by automated driving will be referred to as the traveling start period hereinafter. The traveling start state identification unit 104 determines that the occupant has stopped monitoring the periphery. The monitoring encouragement notification is made from the notification device 17 as described above.

Furthermore, when the action determination unit 102 determines that the occupant has stopped monitoring the periphery during the traveling start period, it may continue the started automated driving without stop. That is, when the control execution unit 103 determines that the occupant has stopped monitoring the periphery during the traveling start period, it may continue the initiated automated driving without stop.

According to the above configuration, it is possible to encourage the occupant to continue monitoring the periphery during a period when it is preferable to continue monitoring the periphery, such as immediately after the start of traveling. In addition, according to the above configuration, the periphery monitoring is simply interrupted without stopping traveling with automated driving. Therefore, the comfort of the occupant is not compromised.

When the action determination unit 102 determines that the occupant has interrupted monitoring the periphery during the traveling start period, it is preferable to cause the vehicle to travel at a speed lower than the set vehicle speed for the started automated driving. That is, when the control execution unit 103 determines that the occupant has interrupted monitoring the periphery during the traveling start period, it may cause the vehicle to travel by at a speed lower than the set vehicle speed of the automated driving. The traveling at the speed lower than the set vehicle speed may mean slow traveling. The slow traveling may mean traveling at a vehicle speed of 10 km/h or less, for example. The lower the vehicle speed, the easier it will be for the automated driving system to avoid approaching obstacles. According to the above configuration, when the occupant stops monitoring the periphery, the vehicle is possible to easily avoid obstacles through automated driving without stopping automated driving.

When the traveling start state identification unit 104 identifies the traveling start operation necessary state, the notification processing unit 151 preferably causes the notification device 17 to provide a traveling start operation notification. The traveling start operation notification is a notification that informs the occupant of what operation should be performed as the traveling start operation. For example, when the accelerator pedal should be depressed as the traveling start operation, a notification is given to inform the driver that the accelerator pedal should be depressed. Thereby, it becomes easier for the occupant to understand what operation they should perform to start traveling when the traveling start operation by the occupant is required to start traveling under automated driving.

When the traveling start state identification unit 104 identifies the traveling start operation unnecessary state, the notification processing unit 151 preferably causes the notification device 17 to provide a traveling start mode notification. The traveling start mode notification is a notification that informs the occupant of how the subject vehicle will start traveling under automated driving. The traveling start mode notification may be, for example, a notification indicating the direction in which the subject vehicle will start. For example, the direction in which the subject vehicle starts may be forward, backward, turn right, turn left, or the like. When the traveling start operation by the occupant is not required to start traveling by the automated driving, traveling by automated driving is started without the traveling start operation by the occupant. In such cases, by informing the occupant of how the subject vehicle will start traveling under automated driving, it is possible to increase the sense of safety of the occupant.

When the traveling start state identification unit 104 determines that the automated driving to be initiated at the traveling start time is the last mile automated driving, it is preferable that the notification processing unit 151 perform the following. The notification processing unit 151 causes the notification device 17 to provide the monitoring encouragement notification while the subject vehicle is traveling in the area identified as the first area by the area identification unit 111. On the other hand, the notification processing unit 151 causes the notification device 17 to provide the second task permission notification while the subject vehicle is traveling in the area identified as the second area by the area identification unit 111. The second task permission notification is a notification that informs the occupant that the second task is permitted. This process may be configured not to be executed when the automation level of the subject vehicle is lower than LV2. When the mode determination unit 122 determines the last mile mode, the traveling start state identification unit 104 may determine that the automated driving to be started at the traveling start time is the last mile automated driving.

According to the above configuration, in the last mile automated driving, in areas where it is preferable for the occupant to monitor the periphery, it is possible to encourage the occupant to monitor the periphery. On the other hand, in areas where there is little need for periphery monitoring, the second task can be permitted. Accordingly, it is possible to provide notifications as needed during the last mile automated driving. In order to reduce the processing load, the area identification unit 111 may be configured not to execute the process unless the mode determination unit 122 determines the last mile mode.

When the action determination unit 102 determines that the occupant is not wearing a seat belt within the traveling start period, it may stop traveling by the started automated driving. That is, when the control execution unit 103 determines that the occupant is not wearing the seat belt within the traveling start period, it may stop traveling by the started automated driving. The traveling start state identification unit 104 determines whether the occupant has not fastened. the seat belt. According to the above configuration, it is possible to prevent the automated driving from continuing when the occupant has not fastened. the seat belt. As a result, it becomes easier to protect the occupant from impacts.

### Traveling Start-Related Process by Automated Driving ECU

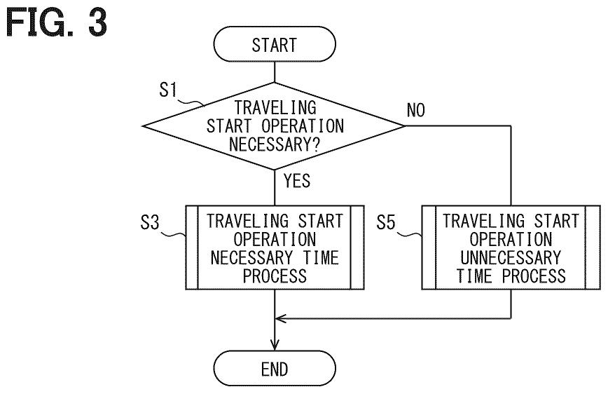

Here, an example of the flow of processes (hereinafter, traveling start- related process) related to traveling start by the automated driving ECU 10 will be described with reference to a flowchart of FIG. 3. The flowchart of FIG. 3 may be started in a case where the power switch of the subject vehicle is turned on. In addition, when the setting of whether to transition to automated driving from the traveling start time can be switched, the setting of transition to automated driving from the traveling start time can also be added as a condition.

First, in step S1, when the traveling start state identification unit 104 identifies the traveling start operation necessary state (YES in S1), the process proceeds to step S3. On the other hand, when the traveling start state identification unit 104 identifies the traveling start operation unnecessary state (NO in S1), the process proceeds to step S5.

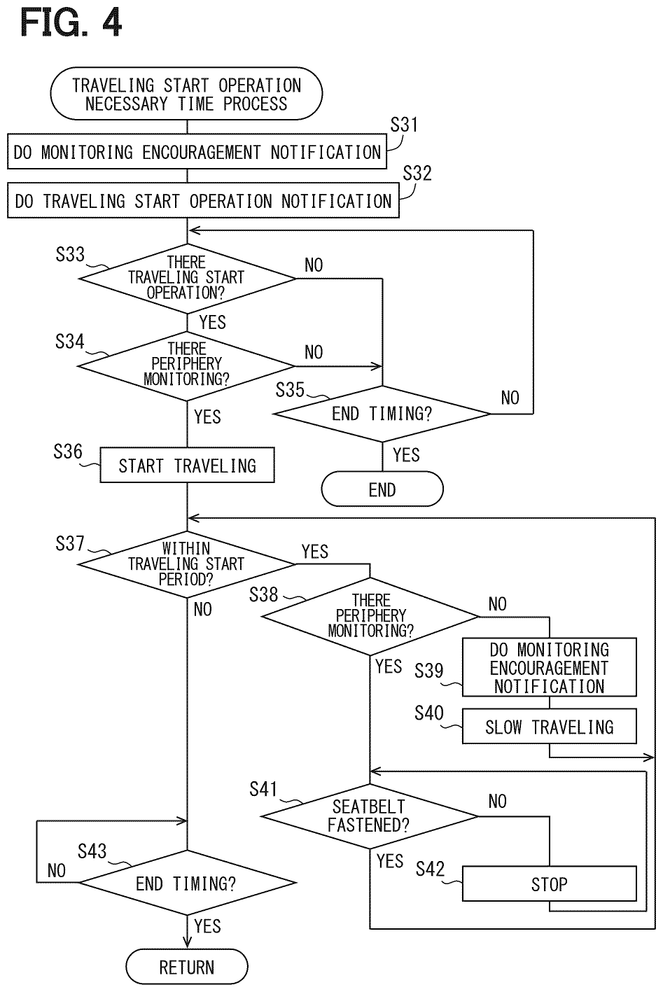

In step S3, the traveling start operation necessary time process is executed, and the traveling start-related process ends. Here, an example of the flow of the traveling start operation necessary time process will be described with reference to the flowchart of FIG. 4.

In step S31, the notification processing unit 151 causes the notification device 17 to provide the monitoring encouragement notification. In step S32, the notification processing unit 151 causes the notification device 17 to perform the traveling start operation notification. The order of the process of S31 and the process of S32 may be switched, or the processes may be executed in parallel.

In step S33, when the action determination unit 102 determines that the traveling start operation has been performed (YES in S33), the process proceeds to step S34. On the other hand, when the action determination unit 102 has not determined that the traveling start operation has been performed (NO in S33), the process proceeds to step S35.

In step S34, when the traveling start state identification unit 104 determines that the occupant is monitoring the periphery (YES in S34), the process proceeds to step S36. On the other hand, when the traveling start state identification unit 104 determines that the occupant is not monitoring the periphery (NO in S34), the process proceeds to step S35.

In step S35, when it is an end timing of the traveling start-related process (YES in S35), the traveling start-related process ends. On the other hand, when it is not the end timing of the traveling start-related process (NO in S35), the process returns to S33 to repeat the process. The end timing of the traveling start-related process may be when the power switch of the subject vehicle is turned off.

In step S36, the control execution unit 103 starts traveling by automated driving. In step S37, the notification processing unit 151 determines whether it is within the traveling start period. When it is determined that it is within the traveling start period (YES in S37), the process proceeds to step S38. On the other hand, when it is determined that the traveling start period has elapsed (NO in S37), the process proceeds to step S43.

In step S38, when the traveling start state identification unit 104 determines that the occupant is monitoring the periphery (YES in S38), the process proceeds to step S41. On the other hand, when the traveling start state identification unit 104 determines that the occupant is not monitoring the periphery (NO in S38), the process proceeds to step S39.

In step S39, the notification processing unit 151 causes the notification device 17 to provide the monitoring encouragement notification. In step S40, the control execution unit 103 causes the subject vehicle to perform slow traveling, and the process returns to S37 to repeat the process. The monitoring encouragement notification and the slow traveling may be continued, for example, until it is determined in S37 that the traveling period has elapsed or until it is determined in S38 that the occupant is monitoring the periphery. The order of the process of S39 and the process of S40 may be switched, or the processes may be executed in parallel.

In step S41, when it is determined that the occupant has fastened the seat belt (YES in S41), the process returns to S37 and is repeated. On the other hand, when it is determined that the occupant has not fastened the seat belt (NO in S41), the process proceeds to step S42. In step S42, the control execution unit 103 stops the subject vehicle, and returns to S37 to repeat the process. The subject vehicle may be stopped, for example, until it is determined in S37 that the traveling start period has elapsed or until it is determined in S41 that the occupant has fastened the seat belt.

In step S43, when it is an end timing of the traveling start-related process (YES in S43), the traveling start-related process ends. On the other hand, when it is not the end timing of the traveling start-related process (NO in S43), the process of S43 is repeated.

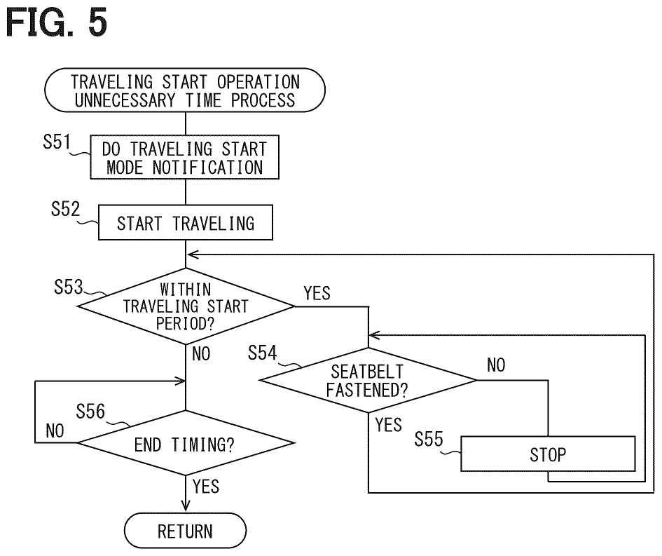

Returning to FIG. 3, in step S5, the traveling start operation unnecessary time process is executed, and the traveling start-related process ends. Here, an example of the flow of the traveling start operation unnecessary time process will be described with reference to the flowchart of FIG. 5.

In step S51, the notification processing unit 151 causes the notification device 17 to provide the traveling start mode notification. In step S52, the control execution unit 103 starts traveling by automated driving. In step S53, the notification processing unit 151 determines whether it is within the traveling start period. When it is determined that it is within the traveling start period (YES in S53), the process proceeds to step S54. On the other hand, when it is determined that the traveling start period has elapsed (NO in S53), the process proceeds to step S56.

In step S54, when it is determined that the occupant has fastened the seat belt (YES in S54), the process returns to S53 and is repeated. On the other hand, when it is determined that the occupant has not fastened the seat belt (NO in S54), the process proceeds to step S55. In step S55, the control execution unit 103 stops the subject vehicle, and returns to S53 to repeat the process. The subject vehicle may be stopped, for example, until it is determined in S53 that the traveling start period has elapsed or until it is determined in S54 that the occupant has fastened the seat belt.

In step S56, when it is an end timing of the traveling start-related process (YES in S56), the traveling start-related process ends. On the other hand, when it is not the end timing of the traveling start-related process (NO in S56), the process of S56 is repeated.

### Last Mile-Related Process by Automated Driving ECU

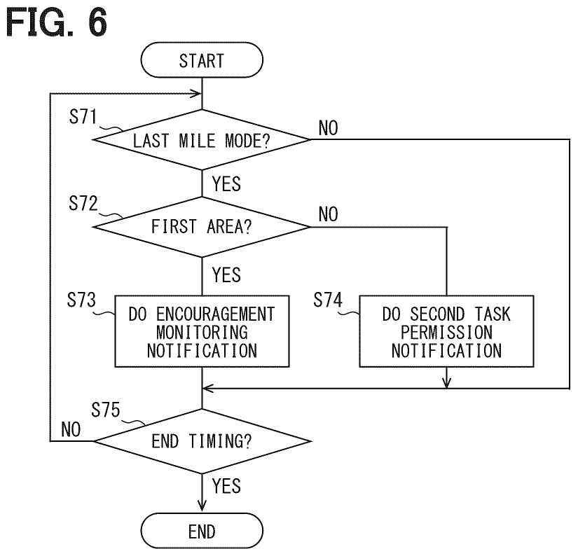

Next, an example of a flow of a process (hereinafter, last mile-related process) related to traveling in the last mile mode by the automated driving ECU 10 will be described with reference to the flowchart of FIG. 6. The flowchart in FIG. 6 may be configured to start when automated driving of the subject vehicle starts in the traveling start-related process. In the flowchart of FIG. 6, an example will be described in which the subject vehicle performs automated driving at LV3 or higher.

First, in step S71, when the traveling start state identification unit 104 identifies the automated driving to be started at the traveling start time as the last mile automated driving (YES in S71), the process proceeds to step S72. On the other hand, when the traveling start state identification unit 104 determines that the automated driving to be started at the traveling start time is not the last mile automated driving (NO in S71), the process proceeds to step S75.

In step S72, when the area identification unit 111 determines that the subject vehicle is traveling in the first area (YES in S72), the process proceeds to step S73. On the other hand, when the area identification unit 111 determines that the subject vehicle is traveling in the second area (NO in S72), the process proceeds to step S74.

In step S73, the notification processing unit 151 causes the notification device 17 to provide the monitoring encouragement notification, and the process proceeds to step S75. In step S74, the notification processing unit 151 causes the notification device 17 to provide the second task permission notification, and the process proceeds to step S75.

In step S75, when it is time to end the last mile-related process (YES in S75), the last mile-related process ends. On the other hand, when it is not time to end the last mile-related process (NO in S75), the process returns to S71 and is repeated. The last mile-related process may end when the power switch of the subject vehicle is turned off, when the vehicle arrives at the destination, and the like.

### Second Embodiment

The present disclosure is not limited to the configuration described in the above embodiment, but can also adopt the following configuration as a second embodiment. The following will describe an example of a configuration of the second embodiment with reference to the drawings.

### Schematic Configuration of Vehicle System

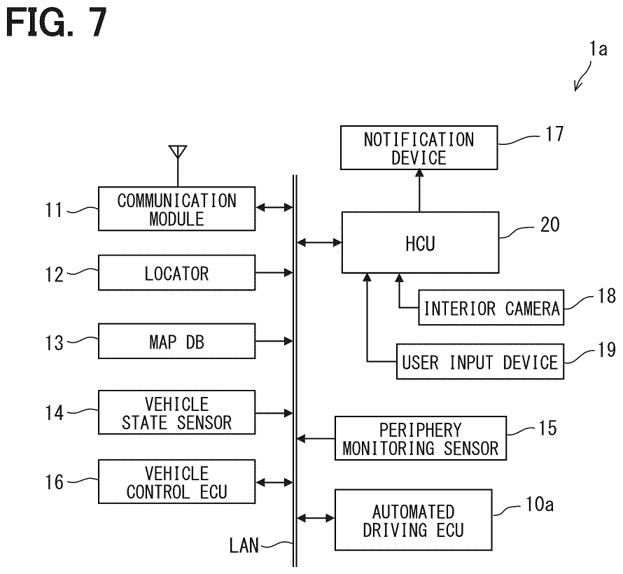

As shown in FIG. 7 a vehicle system 1a includes an automated driving ECU 10a, the communication module 11, the locator 12, the map DB 13, the vehicle state sensor 14, the periphery monitoring sensor 15, the vehicle control ECU 16, the notification device 17, the interior camera 18, and the user input device 19, and the HCU 20. The vehicle system 1a is similar to the vehicle system 1 of the first embodiment, except that the vehicle system 1 includes the automated driving ECU 10a instead of the automated driving ECU 10.

### Schematic Configuration of Automated Driving ECU

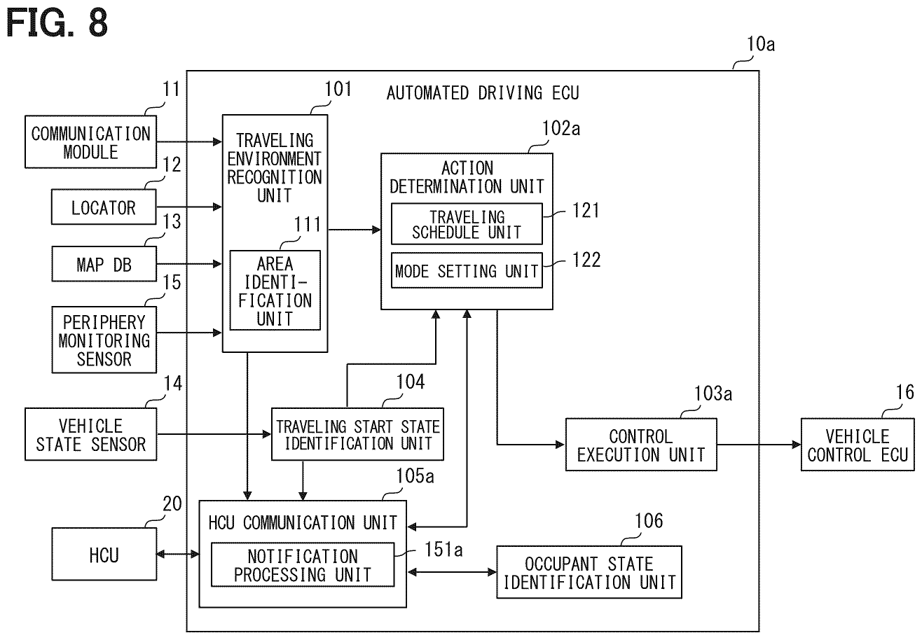

Next, a schematic configuration of the automated driving ECU 10a will be described with reference to FIG. 8. The automated driving ECU 10a is similar to the automated driving ECU 10 of the first embodiment, except for some differences in processing. The automated driving ECU 10a includes a traveling environment recognition unit 101a, an action determination unit 102a, a control execution unit 103a, the traveling start state identification unit 104, an HCU communication unit 105a, and the occupant state identification unit 106 as functional blocks. The automated driving ECU 10a includes the action determination unit 102a instead of the action determination unit 102. The automated driving ECU 10a includes the control execution unit 103a instead of the control execution unit 103. The automated driving ECU 10a includes the HCU communication unit 105a instead of the HCU communication unit 105. Except for these points, the automated driving ECU 10a is similar to the automated driving ECU 10 of the first embodiment. This automated driving ECU 10a also corresponds to a vehicle control device. The execution of the processes of the functional blocks of the automated driving ECU 10a by the computer corresponds to execution of a vehicle control method.

The action determination unit 102a includes the traveling schedule unit 121 and the mode determination unit 122 as sub-functional blocks, similar to the action determination unit 102 of the first embodiment. The action determination unit 102a is similar to the action determination unit 102 of the first embodiment, except for some differences in processing. This different point will be described below. The control execution unit 103a is similar to the control execution unit 103 of the first embodiment, except that it follows the traveling schedule determined by the action determination unit 102a. A notification processing unit 151a is similar to the notification processing unit 151 of the first embodiment, except that some processes are different. This different point will be described below. The process executed by the notification processing unit 151a also corresponds to the notification process.

When the action determination unit 102a determines that the occupant has not fastened the seat belt within the traveling start period, the traveling by the started automated driving is not stopped, and the vehicle is continued to travel temporarily. That is, when the control execution unit 103a determines that the occupant has not fastened. the seat belt within the traveling start period, the traveling by the started automated driving is not stopped, and the vehicle is continued to travel temporarily. The traveling start state identification unit 104 determines whether the occupant has not fastened. the seat belt. A period for the temporary traveling may be set arbitrarily. Furthermore, when the notification processing unit 151a determines that, within the traveling start period, the occupant has not fastened. the seat belt, it causes the notification device 17 to continue providing the monitoring encouragement notification.

According to the above configuration, even when the occupant has not fastened the seat belt, automated driving is not immediately stopped, and comfort for the occupants is not compromised. In addition, by continuing the monitoring encouragement notification, it is possible to reduce the possibility that the occupant will receive an impact while not wearing the seat belt.

### Third Embodiment

In the above-described embodiment, the automated driving ECUs 10 and 10a are configured to correspond to the vehicle control device, but this is not necessarily limited to this. For example, an ECU other than the automated driving ECUs 10 and 10a may correspond to the vehicle control device.

It should be noted that the present disclosure is not limited to the embodiments described above, and various modifications are possible within the scope indicated in the in the present disclosure, and embodiments obtained by appropriately combining technical means disclosed in different embodiments are also included in the technical scope of the present disclosure. Further, the control unit and the method thereof described in the present disclosure may be implemented by a dedicated computer which includes a processor programmed to perform one or more functions executed by a computer program. Alternatively, the device and the method thereof described in the present disclosure may also be implemented by a dedicated hardware logic circuit. Alternatively, the device and the method thereof described in the present disclosure may also be implemented by one or more dedicated computers configured as a combination of a processor executing a computer program and one or more hardware logic circuits. The computer program may also be stored in a computer-readable non-transitory tangible storage medium as instructions to be executed by a computer.

What is claimed is:

1. A vehicle control device configured to be used in a vehicle configured to start automated driving that assists steering, acceleration, and deceleration from a traveling start time, the vehicle control device comprising
at least one of (i) a circuit and (ii) a processor with a memory storing computer program code executable by the processor, the at least one of the circuit and the processor configured to cause the vehicle control device to:
identify a traveling start state which is a state related to the automated driving that starts at the traveling start time;
cause a notification device for providing a notification to an occupant of the vehicle to provide the notification; and
change content of the notification by the notification device according to the identified traveling start state.

2. The vehicle control device according to claim 1, wherein
the at least one of the circuit and the processor is further configured to cause the vehicle control device to:
cause the vehicle to perform the automated driving;
identify, as the traveling start state, at least
whether a traveling start operation by the occupant is necessary to start traveling by the automated driving and
a state of periphery monitoring by the occupant,
when determining that the traveling start operation by the occupant is necessary to start the traveling by the automated driving, cause the notification device to provide the notification that encourages the occupant to monitor a periphery of the vehicle; and
when determining that the traveling start operation has been performed and that the occupant has performed the periphery monitoring, start traveling by the automated driving.

3. The vehicle control device according to claim 2, wherein
the at least one of the circuit and the processor is further configured to cause the vehicle control device to:
when determining that the occupant interrupts the periphery monitoring within a predetermined period after the traveling start time by automated driving, cause the notification device to provide the notification that encourages the occupant to monitor the periphery monitoring with respect to the vehicle; and
when determining that the occupant interrupts the periphery monitoring within the predetermined period after the traveling start time by automated driving, cause the vehicle to continue traveling by the automated driving.

4. The vehicle control device according to claim 3, wherein
the at least one of the circuit and the processor is further configured to cause the vehicle control device to, when determining that the occupant interrupts the periphery monitoring within the predetermined period after the traveling start time by automated driving, cause the vehicle to travel at a vehicle speed lower than a set vehicle speed of the automated driving.

5. The vehicle control device according to claim 2, wherein
the at least one of the circuit and the processor is further configured to cause the vehicle control device to:
identify a seat belt fastening state of the occupant as the traveling start state; and
when determining that the occupant has not fastened a seat belt within a predetermined period after the traveling start time by automated driving, cause the vehicle to stop traveling by the automated driving.

6. The vehicle control device according to claim 2, wherein
the at least one of the circuit and the processor is further configured to cause the vehicle control device to:
identify a seat belt fastening state of the occupant as the traveling start state;
when determining that the occupant has not fastened a seat belt within a predetermined period after the traveling start time by automated driving, cause the vehicle to temporarily continue traveling by the automated driving without stopping the traveling; and
when determining that the occupant has not fastened the seat belt within the predetermined period after the traveling start time by automated driving, cause the notification device to continue the notification that encourages the occupant to monitor the periphery monitoring with respect to the vehicle.

7. The vehicle control device according to claim 1, wherein
the at least one of the circuit and the processor is further configured to cause the vehicle control device to:
identify, as the traveling start state, at least whether a traveling start operation by the occupant is necessary to start traveling by the automated driving; and
when determining that the traveling start operation by the occupant is necessary to start traveling by the automated driving, cause the notification device to provide the notification informing the occupant of what operation should be performed as the traveling start operation.

8. The vehicle control device according to claim 1, wherein
the at least one of the circuit and the processor is further configured to cause the vehicle control device to:
identify, as the traveling start state, at least whether a traveling start operation by the occupant is necessary to start traveling by the automated driving; and
for the vehicle that starts traveling by the automated driving in response to an operation input to activate a driving power source for the traveling of the vehicle, determine that a traveling start operation by the occupant is not necessary to start the traveling by the automated driving.

9. The vehicle control device according to claim 8, wherein
the at least one of the circuit and the processor is further configured to cause the vehicle control device to, when determining that the traveling start operation by the occupant is unnecessary to start traveling by the automated driving, cause the notification device to provide the notification informing the occupant of what traveling start of the vehicle is performed by the automated driving.

10. The vehicle control device according to claim 1, wherein
the at least one of the circuit and the processor is further configured to cause the vehicle control device to:
identify, as the traveling start state, at least a type of the automated driving including last mile automated driving in which the vehicle moves by the automated driving within a limited range that is a range to a destination;
separately identify, as a vehicle traveling area, a first area in which a necessity for periphery monitoring is high and a second area in which the necessity for the periphery monitoring is low;
when identifying the automated driving that starts at the traveling start time as the last mile automated driving, cause the notification device to provide the notification encouraging the occupant to perform the periphery monitoring with respect to the vehicle while the vehicle is traveling in an area identified as the first area; and
while the vehicle is traveling in the area identified as the second are, cause the notification device to provide the notification informing the occupant of permission of a second task different from driving which a driver of the vehicle is permitted to perform.

11. A vehicle control method configured to be used in a vehicle configured to start automated driving that assists steering, acceleration, and deceleration from a traveling start time, the vehicle control method comprising causing at least one processor to:
identify a traveling start state which is a state related to the automated driving that starts at the traveling start time;
cause a notification device for providing a notification to an occupant of the vehicle to provide the notification; and
change content of the notification by the notification device according to the identified traveling start state.
